(19) United States
(12) Patent Application Publication
(10) Pub. No.: US 2009/0183062 A1
(43) Pub. Date: Jul. 16, 2009

(54) Activatable table within webpages in a recursive browser system

(76) Inventor: Joseph Pally, Katy, TX (US)

Correspondence Address: Benjamin Aaron Adler;ADLER & ASSOCIATES, 8011 Candle Lane, Houston, TX, 77071, US

(21) Appl. No.: 12/008,515

(22) Filed: Jan. 11, 2008

(51) Int. Cl. G06F 17/00

(52) U.S. Cl. 715/217

(57) ABSTRACT

Provided herein are computer-implemented methods, computer program products and a recursive computer system adapted to display and activate one or more activatable tables. The activatable tables have one or more cells therewithin, including cells comprising a recursive 3-D calculation engine with an HTML interface (CALCI) that is activatable and deactivatable within ZSpace, and are contained within webpage segments comprising one or more ZCubes in a recursive web browser on a client computer. Calculational and/or behavioral functions are applied to the cell(s) thereby activating the tables. The process is client driven whereby the webpage segments on the client computer contain the logic necessary to trigger animation of the cells.

### COMPUTER PROGRAM LISTING APPENDIX

Computer program listings are submitted on compact disc in compliance with 37 C.F.R. §1.96 and are incorporated by reference herein. A total of two (2) compact discs (including duplicates) are submitted herein. The files on each compact disc are listed below:

| Files | Size (KB) | Date Created |
|---|---|---|
| RecursiveBrowserCode.txt | 40 | May 29, 2006 |
| ZCube.txt | 48 | May 29, 2006 |
| Handwriting.txt | 76 | May 29, 2006 |
| Netvariables.txt | 8 | Nov. 03, 2006 |
| CALCI.txt | 12 | Jan. 02, 2008 |

### BACKGROUND OF THE INVENTION

1. Field of the Invention

The present invention relates generally to the fields of computer technology and web browser systems. More specifically, the present invention provides a system and method to manipulate activatable spreadsheet-like tables comprising webpage segments within a recursive browser environment using a 3-D Calculation Engine (CALCI).

2. Description of the Related Art

The Internet is arguably the most important innovation of the computer generation. To browse or surf the World Wide Web (the Web) is the fastest and most popular method of obtaining information today. However, current web browsers are primarily read only with little interactive capability. The Internet is to “go and visit” and not part of the experience. A user's experience on the Internet is a temporal series of URLs visited. Furthermore, group collaboration on the Web requires user authentication and is generally site specific.

In addition most users are interested only in snippets of a web site they visit. However, a user must open a word processing, drawing or similar application or access another website to utilize or build on these snippets, if desired, or, for example, to create a document or image de novo. Browsers lack the ability to integrate different types of media according to user preferences. Selective access is missing. A live web is not close to being a reality.

Creating a new browser to address these problems is not an easy solution. It is estimated that a new browser release can cost from $10 million to $100 million. In addition the development and release processes are extremely time consuming. As such, one solution is to use the browser itself to expand browser functionalities.

Thus, there is a significant need in the art for improvements in the area of user-driven experiences. Specifically, the present invention is deficient in systems and methods to display, manipulate and/or create content in a recursive browser environment. The present invention fulfills this long-standing need and desire in the art.

### SUMMARY OF THE INVENTION

The present invention is directed to a computer-implemented method performed by a recursive web browser system for activating a table within a recursive webpage. The method comprises displaying, as a recursive webpage segment, one or more tables comprising one or more cells within one or more ZCubes in a recursive browser window and applying one or more functions supported by the ZCube(s) to one or more cells thereby activating the table(s). In a related invention, the method further comprises storing the activated table(s) on a tangible computer storage medium or in a computer memory. In another related invention the table cell(s) comprise a recursive 3-D calculation engine with an HTML interface (CALCI) that is activatable and deactivatable within ZSpace where the method further comprises one or more of a) dynamically loading add-ons, e.g., browser scripts in Javascript or VBScript with additional program logic, comprising domain specific functions within ZSpace to enhance the same or to add to functions used in CALCI, (b) statically evaluating the CALCI cell(s) within an action bar contained in the recursive browser window without changing any CALCI cell unless a specific user-action or event is implemented, (c) dragging the CALCI within the recursive webpage segment, which itself could be a CALCI, or (d) to implement a resizing of the CALCI table by adjusting the cell whereupon the table resizes accordingly. A notable aspect of CALCI is that it is entirely HTML page based and does not depend on a server for any of the calculations. It is not a standalone binary like conventional executable applications.

The present invention also is directed to a computer program product. The computer program product comprises a tangible computer useable medium having a computer readable program, wherein the computer readable program, when executed in a recursive web browser system on a client computer comprising at least a memory and a processor, causes the client computer to: provide one or more activatable tables defining one or more cells therein within one or more recursive webpage segments in a ZCube and access one or more ZCube supported functions applicable to the cell(s) comprising the activatable table, where the recursive webpage segment(s) contains the function logic therein. In a related invention, the client computer further triggers animation or other logic from the table cell(s) and in a manner effective to change the document object model of the container ZSpace without changing the table itself. In a related invention the table cells provided by the computer program product comprise CALCI as described herein.

The present invention is directed further still to a recursive computer system for activating one or more activatable tables within a segment of a recursive webpage. The computer system comprises a computer having a processor and a recursive web browser configured to recursively display in a browser window thereof one or more recursive webpages having one or more activatable tables contained therein and a computer memory coupled to the processor storing the computer program described herein and further storing instructions adapted to be executed by the processor to at least enable operation thereof within the recursive webpages. In another embodiment of the present invention, the recursive computer system further comprises means for storing the computer program product onto a computer-readable storage medium.

In another related embodiment of the present invention, the recursive computer system further comprises a means for launching a user-requested action to create, to retrieve or to evaluate statically one or more activatable tables. In yet another related embodiment of the present invention, the recursive computer system further comprises a network connection to one or more other computers having a recursive web browser comprising a network.

Other and further aspects, features and advantages of the present invention will be apparent from the following description of the presently preferred embodiments of the invention. These embodiments are given for the purpose of disclosure.

### BRIEF DESCRIPTION OF THE DRAWINGS

So that the matter in which the above-recited features, advantages and objects of the invention, as well as others which will become clear, are attained and can be understood in detail, more particular descriptions of the invention briefly summarized above may be had by reference to certain embodiments thereof which are illustrated in the appended drawings. These drawings form a part of the specification. It is to be noted, however, that the appended drawings illustrate preferred embodiments of the invention and therefore are not to be considered limiting in their scope.

FIG. 1 depicts a recursive browser window illustrating various attributes of CALCI, including a ZCube containing operations executable thereon.

FIG. 2 depicts a recursive browser window demonstrating the addition of various creative features, including user-implemented handwriting, to CALCI.

FIG. 3 depicts a recursive browser window illustrating how models may be implemented in CALCI.

FIG. 4 depicts a recursive browser window illustrating how CALCI can be inserted into slide elements.

FIG. 5 is a flowchart of the CALCI process.

### DETAILED DESCRIPTION OF THE INVENTION

As used herein, the term “a” or “an” may mean one or more. As used herein in the claim(s), when used in conjunction with the word “comprising”, the words “a” or “an” may mean one or more than one. As used herein “another” or “other” may mean at least a second or more of the same or different claim element of components thereof.

As used herein, the term(s) “recursive browser” or “zBrowser” refers to a browser that uses existing browsers to enhance their functionality and to provide 3 dimensional multipart full browser functionality to improve browser experience.

As used herein, the term “action bar” refers to a targeting bar, which may be the conventional URL bar, that can also be triggered from html or :href calls invoking, e.g., one or more web actions, web sites, web services, or action triggers.

As used herein, the term(s) “ZBox” refers to a part of a ZPage that contains an html object(s), for example, but not limited to, images, scripts, shockwave, and a recursive browser. ZBoxes are copyable and individually and selectively formattable with drag-drop of style text.

As used herein, the term(s) “Zpage” or “ZBrowser page” or “recursive webpage” refers to a container of one or more ZBoxes/ZCubes that encompasses logic to display, edit, move, browse, rotate, hide, animate, and run scripts within the recursive browser. Parts of a ZPage are copyable and individually and selectively formatable with drag-drop of style text. A ZPage can be controlled by Zebra, i.e. ZBox algebra, and is composed from data (that could be stored separately) with logic coming from the ZCube server files. ZPage can receive and conduct Jumping-Jax (dynamically obtained server based javascripts), effecting dynamic page maintenance. A ZPage also may be called ZSpace or zWorld when comprising multiple layers.

As used herein, the term(s) “ZEditor” refers to a ZPage or recursive webpage that is a page, either local or on the web, primarily composed of HTML, which allows parts of the page, e.g., ZBoxes or ZCubes comprising one or more of the same, which may be shared by groups of users, groups of ZBoxes, window layer, or background-layer, to be selected, edited, or dragged-and-dropped, to effect creation of new objects upon demand, by dragging-dropping, double-clicking, or pasting, based on instructions of the incoming HTML or script of diverse media, to receive events from and into individual ZBoxes and routing them, to contain zBrowser(s), VML, SVG or other hand-drawings/handwritings with pointers to remote or local ZBoxes or with individually addressable ZBoxes or controls.

As used herein, the term(s) “ZCube” refers to a collection of one or more ZBoxes contained within a ZPage or recursive webpage. Unless specifically indicated otherwise the terms “ZBox” and “ZCube” are interchangeable. A ZCube may be made from templates that are stored in a gallery. The ZCube may be moved/rotated over a user-defined path and then may be animated. A ZCube can be made “read only”. A ZCube may have pushpins added to it or comprise other pointers or toggles, such as, but not limited to, functions that lock a ZCube, keep a ZCube the same size, hide a ZCube, make a ZCube transparent, make a ZCube read only or add a scrollbar thereto. A ZCube may be in multiple layers. Within ZCube(s) a user may download or upload files, such as spreadsheet, music, video, photos, games or other media files, play games, and/or use.

As used herein, the term(s) “ZCube world” refers to one or more sets of ZCube collections displayed under one context to the user. A ZCube world may contain ZPages.

As used herein, the term “ZCycle bin” refers to a location within the recursive web browser where deleted ZCubes are stored.

As used herein, the term “NetVariable” refers to a JAVA servlet that provides data persistency for user defined variables on a web server. NetVariable supports two action modes, SET and CACHE.

As used herein, “recursive 3-D Calculation Engine” refers to a calculation engine that can recursively contain a similar calculation engine in its most fundamental element (in this case an HTML table cell). A CALCI can contain other Calci, web pages, web elements like pictures than can then be used for mathematical operations like addition, multiplication, etc. and special effects. For example, an image when added to another in different ways can give the HTML for two of them added or overlaid.

As used herein, CALCI refers to a 3-D calculation engine that has an HTML interface. CALCI is different from a standalone spreadsheet application, since it is a functionality of ZCubes omni-functional platform that then contains the API for all known conventional spreadsheet functions (like SUM, SIN, COS, etc.) and control structures (like FOR, WHILE, etc.), other known/unknown mathematical functions and other APIs. CALCI is an integral part of ZCubes functionality, and not a standalone spreadsheet functionality. CALCI is backward compatible with spreadsheet notations, but uses pure JAVASCRIPT functions and interfaces to achieve all functionality. CALCI can also interact with all functions in ZSpace API, thus enhancing ZCubes with full calculation ability.

As used herein “segment” refers to webpage segments or tables that have functionality typically provided by spreadsheet applications in the desktop world, but done using webpage DOM. Conventional functional APIs may be provided by known spreadsheet programs, such as QUATTRO PRO®, LOTUS 123®, MS EXCEL®, GNUMERIC®, etc., on a desktop, but CALCI provides the function within the webpage itself, using functionalities of the HTML DOM and script alone.

In one embodiment of the present invention, there is provided a computer-implemented method performed by a recursive web browser system for activating a table within a recursive webpage, comprising displaying, as a recursive webpage segment, one or more tables comprising one or more cells within one or more ZCubes in a ZSpace of a recursive browser window; and applying one or more functions supported by the ZCube(s) to one or more cells thereby activating the table(s). Further to this embodiment the method comprises storing the activated table(s) on a tangible computer storage medium or in a computer memory.

In both embodiments triggering animation or other logic from the table cell(s) may be a client driven process effective to change the document object model without changing the table itself. Also, the webpage segment may contain logic for the one or more functions. In addition, the webpage segment further may comprise one or more models having a formula input and output where the model(s) comprising one or more function blocks. Furthermore, the webpage segment further may comprise one or more floating recursive 3-D calculation engines that provide a calculation medium. Also, in both embodiments one or more cells may contain a data structure. Examples of a data structure are one or more pictures, one or more numbers, one or more complex numbers, a coordinate set, a spreadsheet, or a calendar.

In one aspect of both embodiments, the step of applying function(s) may comprise applying one or more spreadsheet calculational functions from within the webpage segment to the one or more table cells where the webpage segment contains the logic therefor.

In another aspect the step of applying function(s) may comprise applying one or more control structures to the one or more table cells, said control structures operable to execute cell instructions based on values or conditions in another cell instruction during calculation iterations. In this aspect the control functions may be time triggered.

In yet another aspect the step of applying function(s) may comprise dragging and dropping content into the cell(s) and expanding the cell(s) to display the content therein. Examples of content are picture(s) or a web link.

In yet another aspect the step of applying function(s) may comprise integrating one or more behavioral effects into the cell(s). Examples of the applied effect comprise rotating the cell(s) or are a special effect that is integrable within the cell(s).

In yet another aspect, the step of applying function(s) may comprise inputting numbers or other representational values or pictures into one or more cells of one or more tables via drag/drop or copy/paste actions or AJAX calls from other data sources. Further to this aspect the step of applying function(s) may comprise converting the table(s) automatically into lookup tables or into recursive 3-D calculation engine(s) having an HTML interface (CALCI) and applying further standard calculational functions thereto.

In these embodiments in an alternate aspect the table cells may comprise a recursive 3-D calculation engine with an HTML interface (CALCI) that is activatable and deactivatable within ZSpace. In all alternate aspects CALCI cells may be interconnected and interchangeable. Further to this alternate aspect the method comprises dynamically loading add-ons comprising domain specific functions within ZSpace to enhance the same or to add to functions used in CALCI. Also, the recursive browser window may comprise an action bar, the method further comprising statically evaluating the CALCI cell(s) within the action bar without changing the previous value of the cell unless a specific user-action or event is implemented. In addition the method may comprise dragging the CALCI within the recursive webpage segment to implement a resizing of the CALCI whereupon the table resizes accordingly.

In this alternate aspect CALCI may implement one or more method steps comprising expanding a URL dragged and dropped therewithin or appending and merging elements from one or more other CALCI therewithin or inserting elements thereof into one or more of document elements, slide elements or drawing elements as a grid with calculation ability. Also, CALCI may implement method steps comprising selecting one or more vector objects in the ZSpace and manipulating the vector object(s) via mathematical expressions and JAVASCRIPT code entered into one or more CALCI cells. In addition, CALCI may implement a method step comprising referring to other CALCI cell(s), an HTML object, an XHTML object or an XML object in ZSpace via one or more formulas contained therein or via NetVariables. Furthermore, CALCI may implement method steps comprising showing a help feature for a ZCube API function upon its entry into CALCI by matching the function prefix to the closest API function name and accepting the entered function upon pressing the keyboard space bar.

Further still in these alternate aspects CALCI may implement a method step comprising enabling shortcuts to calculational functions upon entry of one or more keystrokes assigned to represent the function. Further still CALCI may comprise a model formula having a name and one or more input parameters at specific identifiable locations therewithin where CALCI implements a method step comprising calculating output values from the input parameters comprising the model such that the output values used in further calculations therewithin. Further still CALCI may implement a method step comprising graphically or pictorially representing a number within a cell, including the graphical or pictorial representation of a value resulting from a calculation applied to one or more cells containing the representations. Further still CALCI may implement a a method step comprising entering a multidimensional array into a cell thereof using a notation [[2,3],[4,3]].

In another embodiment of the present invention there is provided a computer program product, comprising a tangible computer useable medium having a computer readable program, where the computer readable program, when executed in a recursive web browser system on a client computer comprising at least a memory and a processor, causes the client computer to provide one or more activatable tables defining one or more cells therein within one or more recursive webpage segments in a ZCube in a ZSpace of a recursive browser window; and access one or more ZCube supported functions applicable to the cell(s) comprising the activatable table, where the recursive webpage segment(s) contains the function logic therein. Further to this embodiment the the client computer triggers animation or other logic from the table cell(s) and in a manner effective to change the document object model without changing the table itself.

In both embodiments the webpage segment further may comprise one or more models having a formula input and output, said model(s) comprising one or more function blocks. Also, the webpage segment may comprise one or more floating recursive 3-D calculation engines that provide a calculation medium. In addition, one or more cells may contain a data structure. Particularly, the data structure may be one or more pictures, one or more numbers, one or more complex numbers, a coordinate set, a recursive 3-D calculation engine, or a calendar.

In one aspect of both embodiments the applied functions may be standard spreadsheet calculational functions contained within the webpage segment. In another aspect the applied functions may comprise one or more control structures operable to execute cell instructions based on values or conditions in another cell instruction during calculation iterations. In this aspect the control structures may be time-triggered. In an alternative aspect, the applied functions may be behavioral functions operable to integrate a behavioral effect into the cell(s). Examples of behavioral effects are cell rotation or a special effect integrable within a ZCube.

In another aspect the applied function may be a drag/drop function or copy/paste function or where the applied function enables AJAX calls from other data sources. In this aspect the functions may operate to input content into the cell(s) comprising the activatable table(s). Particularly, content may be one or more numbers or other representational values. Further to this aspect the functions may operate to convert the table(s) automatically into lookup tables or into a recursive 3-D calculation engine contained with an HTML interface (CALCI) and to apply further calculational functions thereto. In yet another aspect the dragged/dropped content may comprise a picture or a web link where the functions further operate to expand the cell to display the content therein.

In these embodiments in an alternate aspect the table cells may comprise a recursive 3-D calculation engine with an HTML interface (CALCI) that is activatable and deactivatable within ZSpace, as described supra. In all alternate aspects CALCI cells may be interconnected and interchangeable. Further to this alternate aspect the ZCube supported functions operate to perform the computer-implemented method steps on the one or more CALCI as described supra.

Also, in this alternate aspect, CALCI may operate to expand a URL dragged and dropped therewithin or to append and to merge elements from one or more other CALCI therewithin or to insert elements thereof into one or more of document elements, slide elements or drawing elements as a grid with calculation ability. Also, CALCI may operate to select one or more vector objects in the ZSpace and to manipulate the vector object(s) via mathematical expressions and JAVASCRIPT code entered into one or more CALCI cells. In addition, CALCI may operate to refer to other CALCI cell(s), an HTML object, an XHTML object or an XML object in ZSpace via one or more formulas contained therein or via NetVariables. Furthermore, CALCI may operate to show a help feature for a ZCube API function upon its entry into CALCI by matching the function prefix to the closest API function name and to accept the entered function upon pressing the keyboard space bar.

Further still CALCI may operate to enable shortcuts to calculational functions upon entry of one or more keystrokes assigned to represent the function. Further still CALCI may operate to graphically or pictorially represent a number within a cell, including the graphical or pictorial representation of a value resulting from a calculation applied to one or more cells containing the representations. Further still CALCI may operate to enter a multidimensional array into a cell thereof using a notation [[2,3],[4,3]]. Further still CALCI may comprise a model formula having a name and one or more input parameters at specific identifiable locations therewithin where CALCI operates to calculate output values from the input parameters comprising the model, said output values used in further calculations therewithin.

In yet another embodiment of the present invention there is provided a computer system for activating one or more activatable tables within a segment of a recursive webpage, comprising a computer having a processor and a recursive web browser configured to recursively display in a browser window thereof one or more recursive webpages having one or more activatable tables contained therein; and a computer memory coupled to the processor storing the computer program product described supra and further storing instructions adapted to be executed by the processor to at least enable operation thereof within the recursive webpages.

Further to this embodiment the recursive computer system may comprise means for storing the computer program product onto a computer-readable storage medium. In another further embodiment the recursive computer system may comprise means for launching a user-requested action to create or retrieve one or more activatable tables. In this further embodiment the means for launching a user-requested action may be an action bar within a recursive browser window or may be an address bar located in a browser platform associated with the recursive web browser which triggers the action bar. An example of a user-requested action may be a static evaluation of a CALCI comprising the activatable table. In yet another further embodiment the recursive computer system may comprise a network connection to one or more other computers having a recursive web browser comprising a network.

A computer-based recursive web browser system, including methods and applications useful therein, is effective to generally control, manipulate or modify content within a recursive browser environment. The recursive browser comprises an action bar within the ZBrowser window or ZPage or recursive webpage as an entry point for any retrievable URL or executable action trigger within the zBrowser environment. The ZBrowser is enabled to recursively display one or more zPages within the browser window whether containing content or blank. Furthermore, using the action bar, a user may interact or create within a ZPage or recursive webpage or may open one or more ZCubes within ZPage(s) or recursive webpages and retrieve or create content therein.

ZCubes is a thin web-browser based environment without add-ins or plug-ins and has the capabilities of a fully functional browser. A ZCubes environment allows a user to integrate a wide variety of media, to manage content and to save and to store content. Generally, within a recursive browser window, ZCubes enables infinite page size in the x-, y- and z-directions, linked ZBoxes and addressable ZBoxes. Both ZBox and ZCubes can be script driven or implemented with drag/drop processes. ZCube(s) may include layers and hierarchical windows thereby forming a Zworld with multiple layers. Each ZCube independently may be sized, layered, positioned, formatted, zoomed or unzoomed, scripted, copied, swapped, deleted and extracted. A ZCube may comprise any arbitrary HTML, applications, recursively included ZCubes or browser components. Also, a ZCube can wrap any arbitrary HTML.

A ZCube also may represent actions, triggers or locators performable on the Web. ZCubes enables arithmetical operations, i.e., adding, subtracting, multiplying and dividing, along with actions or functions such as, but not limited to, merging, swapping, deleting, and copying. Recursive browser systems, including at least ZCubes and ZCube functions and features applicable thereto, are disclosed in co-pending and commonly owned patent applications U.S. Ser. No. 11/521,160 and U.S. Ser. No. 11/786,565 which are incorporated herein by reference in their entireties.

Provided herein are computer-implemented methods, computer program products and recursive computer systems adapted and/or configured to display and activate activatable tables contained in webpage segments within one or more ZCubes in a recursive web browser window. ZCubes may integrate spreadsheet-like functions therewithin without using any existing spreadsheet programs, as are known and standard in the art. Thus, these functionalities, i.e., the spreadsheet logic, are entirely inside the client.

Particularly, segments of webpages within the ZCube(s), that comprise one or more tables activated by calculation and/or behavior, have conventional spreadsheet referencing and calculation mechanisms that can interact with and are an inherent part of the webpage and control structures (like FOR, WHILE, etc.) function such as FOR, WHILE, as control structures, where the control structures may execute cell instructions based on the values/conditions in another cell instruction during calculation iterations, however, may be time triggered than calculation iteration triggered. i.e., The iterations may be done every step of the time trigger than the calculation triggers. In addition, within ZCube(s) the webpage segments can access local or remote resources using any and all conventional data transfer mechanisms and can instantiate data structures using JAVASCRIPT or VBScript, which are loaded dynamically or statically, on the webpage itself. The data structures can instantiate any type, including objects, and are not constrained to primary data types.

Thus, although the ZCubes do not comprise standard spreadsheet programs, standard worksheet functionalities are integrated therein using a 3-D Calculation Engine or CALCI. As are known and standard in the art, these functionalities comprise database functions, date and time functions, engineering functions, financial functions, information functions, logical functions, lookup and reference functions, math and trigonometry functions, statistical functions, text functions, and external functions. One of ordinary skill in the art is well able to determine what specific functions comprise each of these categories. Also, functions, e.g., FOR, WHILE, etc., function as control structures, where the control structures may execute cell instructions based on the values/conditions in another cell instruction during calculation iterations. Control structures may be time triggered rather than calculation iteration triggered. i.e., the iterations may be done every step of the time trigger rather than the calculation triggers.

An activatable table in CALCI may comprise a standard format containing rows and columns where each row has a number and each column has one or more alphabetic letters or numbers. A cell is the intersection of a row and column and is referenced with Column letter or number Row number notation, for example A1 or D2. An activatable table may comprise one or more cells each of which may comprise, without being limiting, a CALCI containing, e.g., a calendar or other table-like object, or any other data structure, for example, but not limited to, pictures, a complex data structure, such as points or coordinates for representing ZSpace objects and other attributes, complex numbers, etc. that can be used for downstream functionality.

For example, generally, a table may be activated by models or webpage segments that have a formula input and output that are used as function blocks. These models or webpage segments may comprise floating segments of CALCI that give the calculation medium. These do not use VBA extensions since the webpage segments themselves are evaluated out of CALCI loops, but internally within the ZCube(s). Thus, provision is made for the entirety of CALCI functions and the logic to be contained within a webpage instead of using ajax evaluation on the server. As such, triggering animation or other logic from the table cells is client driven and changes the rest of the document object model, other than the table itself.

CALCI cells are contained entirely in an HTML table, not a spreadsheet representation. Hence there could be many CALCI in a single ZSpace. Formulae can connect them to each other. A CALCI cell can refer to an HTML/XHTML/XML object (MAP, Image, website) contained in ZSpace. HTML DOM. HTML Table and CALCI are interchangeable. CALCI behavior may be activated and deactivated. Also, cells in CALCI may be evaluated statically, e.g., in the action bar, such that the value will not be changed until the user decides to change it or until a special event happens. Thus, a statically evaluated cell will not change its value after the evaluation.

All objects represented in CALCI are representations for ZSpace JAVASCRIPT functions. Vector objects in CALCI may be manipulated in the ZSpace using mathematical expressions and javascript code that is entered into a CALCI cell. A vector object or ZSpace object may be selected in CALCI to get its name into the edit cell text. For example, =ZOBJECT(“bg_VML_Shape1”).style.width=A3 places the value in A3 and givies it to the ZObject “bg_VML_Shape1”, where “bg_VML_Shape1” is obtained by clicking on the vector object in ZSpace. Reference to other CALCI Cells in other ZSpaces can be achieved using NetVariables. NetVariables are defined herein and disclosed in co-pending and commonly owned patent application U.S. Ser. No. 11/636,161 which is incorporated herein by reference in its entirety.

As with ZCubes basic operations may be applied to a CALCI table per se and/or to one or more cells contained therein. These operations may be accessed from the action bar or from a tool bar contained within the ZCube comprising the CALCI or within the CALCI itself. For example, basic operations applicable to CALCI include activate, cut, paste, and copy. The contents of all displayed CALCI may be cleared or only the values cleared therefrom or the CALCI and/or cell(s) and/or the contents thereof may be formatted. Row and column operations comprise insert or delete one or more rows and/or columns. Charts or graphs may be generated from the contents of one or more CALCIs. Graphs may be, although not limited to bar graphs or may comprise clustered columns with a three-dimensional effect. The font, font-weight and style, including color, size, borders, format, and decoration, may be changed. Comments may be inserted into CALCI or its cells. These operations comprise a ZCube called ZTips which is accesible from the action bar.

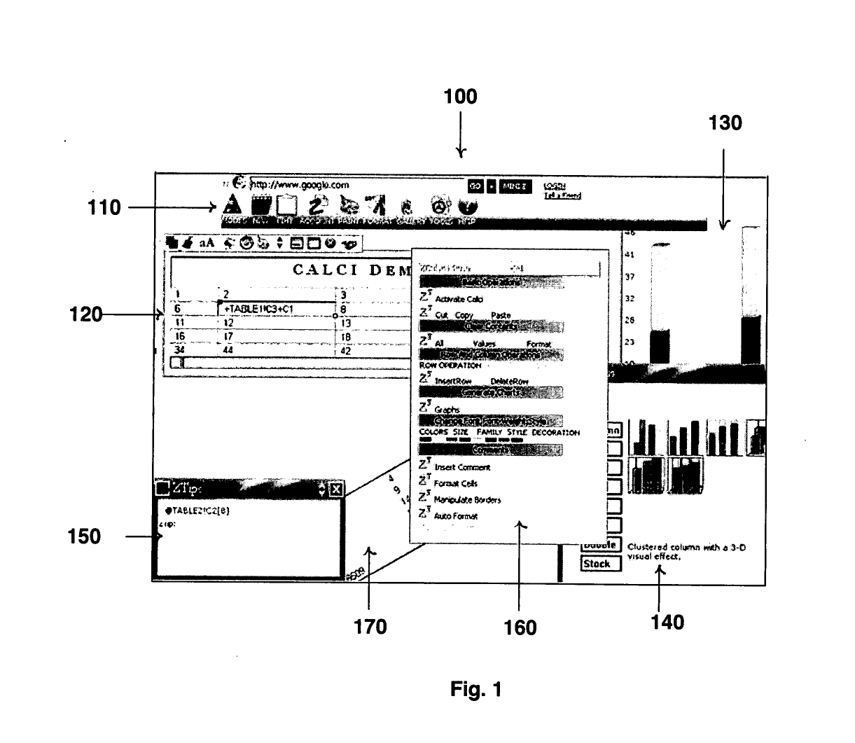

FIG. 1 depicts a recursive browser window 100 having an action bar 110. The recursive browser window displays ZCubes comprising a CALCI DEMO 120, a bar graph 130, and a graph of columns 140 clustered with a 3-dimensional visual effect. The ZTips ZCube 150 is expanded to present the operations 160 applicable to ZCubes and/or CALCI tables and/or CALCI cells. Also, a chart 170 illustrates that ZCubes may be rotated. In addition the positioning of the ZCubes demonstrates that they may be layered or tiled within the window.

Within an activatable table, complex or simple objects may be represented with pictorial representations in cells, e.g., 3 apples as 3 pictures of apples, where complex arithmetical operations are performed on them. For example, the arithmetical statement 3 apples+2 apples=5 apples is shown graphically with apples of count indicating the value of the cell, after applying DSUM to the cells containing pictorially 3 and 2 apples. Also, geometrical shapes may be represented in cells and can be used in formulas. A ZCIRCLE is a circle represented in the ZSpace world, virtual and/or real. For example, ZCIRCLE(1,2,2) is a circle centered at 1,2 with a radius 3 in cell D1 and CIRCLE(3,4,5) is a circle centered at 3,4 with radius 5 in cell E1. A formula (x2−x1)̂A2+(y2−y1)̂2 can calculate the distance between the centers, i.e., ZDISTANCE(D1.Center, E1.Center). This value can be used if in a formula as value or displayed in a cell. In addition an array, e.g., a multidimensional array may be entered into one or more cells in CALCI using the notation [[2,3],[4,3]].

Features applicable to ZCubes may be integrated into one or more of the table cells as CALCIs. For example, a cell or CALCI may be rotated. Also, one or more special effects applicable to ZCubes may be applied to a cell or CALCI. In one particular example the applied special effect is a material background comprising one or more of a marquee mode, a halo effect, rain, stone, a feather, or cork. In another particular example the applied special effect is a physical force comprising one or more of gravity, an electrical or charging force, a magnetic force or the action of air, water, space, or wind upon the cells.

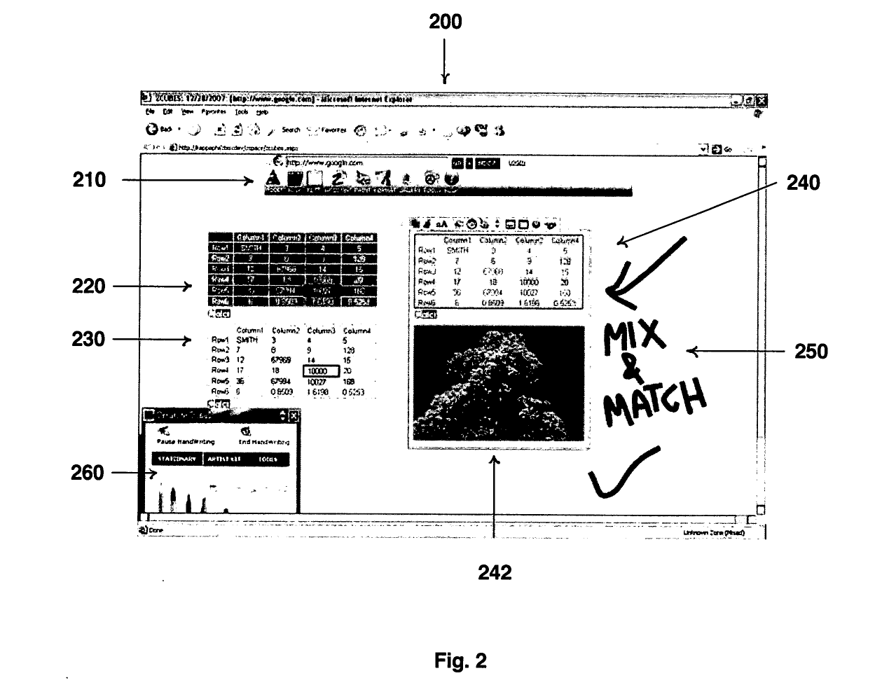

CALCI elements may be appended and merged, as in ZCubes, with pictures, including handwritten or hand-drawn content, and other CALCI elements as desired by the user. FIG. 2 depicts a recursive browser window 200 having an action bar 210. CALCI tables 220, 230 illustrate how different colors and shadings may be applied to the cells comprising the same. CALCI table 240 illustrates how a picture 242 may be appended thereto. User-implemented handwriting 250 may be included as content. Also the recursive browser window displays a ZCube comprising a Creative Panel 260, which may be be accessed from the action bar, that enables the user-implemented handwriting. Handwriting or hand-drawing in a recursive browser system is disclosed in co-pending and commonly owned patent application U.S. Ser. No. 11/445,441 which is incorporated herein by reference in its entirety.

A link or picture may be dragged and dropped into a table cell or CALCI which expands to display the link or picture therewithin. Also, number values may be inputted into tables by drag/drop, copy/paste or AJAX calls from other data sources. In addition tables may be converted automatically into lookup tables or CALCIs to trigger further calculations. Furthermore, a CALCI may be dragged and resized within the webpage whereupon the rest of the CALCI responds by resizing, in a non-spreadsheet implementation.

URLs may be dragged and dropped into the cells to be expanded by CALCI using ZSpace logic. All expressions and functions used in the CALCI may be evaluated from the ZBrowser action bar, yielding results, but not storing the results in the CALCI cells. The functionality of ZSpace can be enhanced by dynamically loading “add-ons” which can be domain specific functions, such as “geometry”, for example, and adding to the javascript functions available for CALCI to use.

Help for the appropriate ZCubes API function may be shown as soon as the function is typed into a CALCI cell and accepting A formula is accepted if the space bar is pressed and including additional details. This will match the given formula prefix that most closely matches in the API universe. For example, SUB (space) will pull up SUBSTITUTE and enter it into the editor, since SUBSTITUTE is the closest match among the equations. Also, shortcuts, as described apply to the closest valid range of valid input. Non-limiting examples are using ++ as a shortcut to SUM, Using − as a shortcut to MINUS function, using ** as a shortcut to PRODUCT function., and using −*, etc. to represent SUMX2PY2, etc. Similar shortcuts include +*, ++2, etc. Any special shortcuts generally would start with an extra +. In addition, cells may be extracted from a CALCI upon selecting and entering a keystroke to launch a new CALCI with just the cells. Effectively this is copy/paste, but the copied/pasted cell(s) becomes a completely new CALCI.

CALCI can have a formula, with input parameters and calculated output values at specific identifiable locations, which is standard in CALCI, with a name for the CALCI table, e.g., MortgageCalc, and then a formula, e.g., =MODEL(“MortgageCale”,1000,1999) where the second parameter on are inputs to the model. The 3-D calculation engine uses models to calculate output and uses it in further calculations. A non-limiting example of a model is:

<TABLEid=MathModel onmouseup=SSCellMouseUp(event)
class=SpreadSheet
oncontextmenu=MenuRequestClick(event);GetEventCancelled(event)
onmousmove=SSCellMouseMove(event)
onmousedown=SSCellMouseDown(event)
onkeydown=SSCellCatchKey(event)
ondragstart=GiveTableElementToDrag(event)
ondblclick=GetEventCancelled(event) style=“WIDTH: 187px”
onclick=GetEventCancelled(event) border=1 selectedSection=“1,1;1,1”
model=“true”>
<CAPTION>
PowerModel by SH
</CAPTION>
<TBODY>
<TR>
<TD class=“sshl_t sshl_t”
id=TEST1 style=“BACKGROUND-COLOR: peachpuff”
editing=“false” formula=“=C2”>292.82</TD>
<TD class=“ sshl_f” id=TEST2 style=“WIDTH: 137px” value=“2.0”
editing=“false”>2.0</TD>
<TD class=“ sshl_f” id=TEST3 editing=“true”>3</TD></TR>
<TR>
<TD class=“ sshl_t sshl_f” style=“BACKGROUND-COLOR:
peachpuff”
editing=“false” formula=“+B1+C1”>12.1</TD>
<TD class=“sshl_f sshl_f” style=“WIDTH: 137px; CURSOR:
hand; HEIGHT: 35px;
BACKGROUND-COLOR: peachpuff” editing=“false”
formula=“=POWER(A2,2)”>146.41</TD>
<TD class=“ sshl_t sshl_f” style=“BACKGROUND-COLOR:
peachpuff”
editing=“false” formula=“+B2*2”>292.82</TD></TR>
<TR>
<TD>11</TD>
<TD style=“WIDTH: 137px”>12</TD>
<TD>13</TD></TR></TBODY></TABLE>

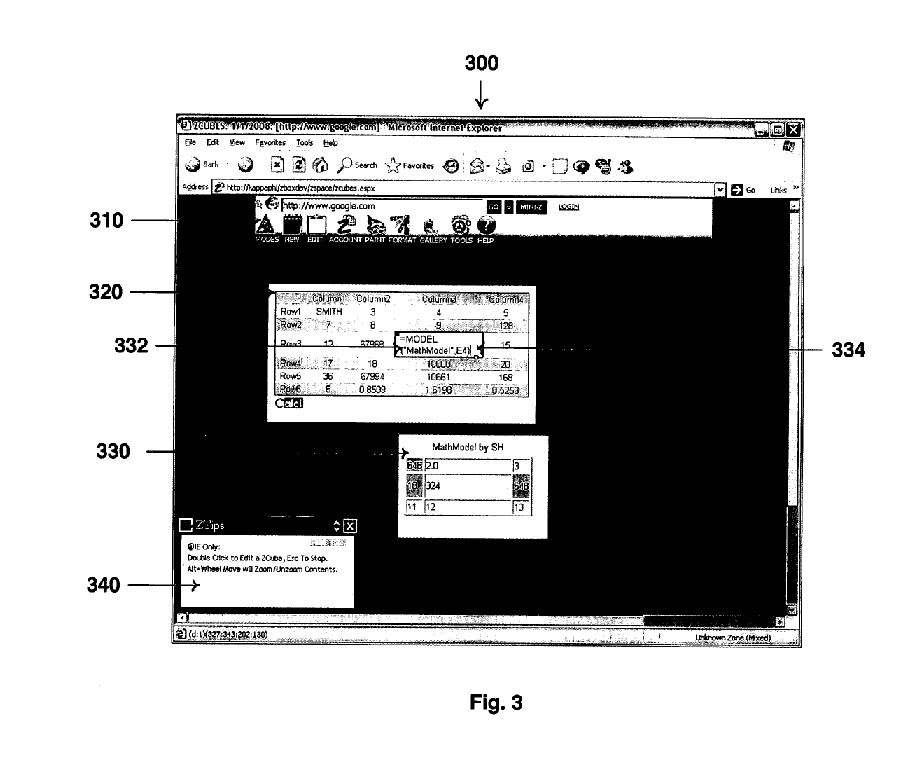

FIG. 3 depicts a recursive browser window 300 having an action bar 310. The recursive browser window contains a CALCI 320 in a ZCube in which MathModel 332 is the name of the model 330 and E4 334 contains the value “15” that is used to make the calculation with the calculations as per the model and giving result “648” shown in the model 330. Also the recursive browser window displays a ZCube comprising ZTips 340, which may be be accessed from the action bar, providing general instructions to manipulate ZCubes. Models are calculated whenever required, not during the full calculations of the ZCubes interspersed formulae. Models may be dragged and dropped from listings of models, that may be created by someone other than the author as HTML tables with or without CALCI functionality.

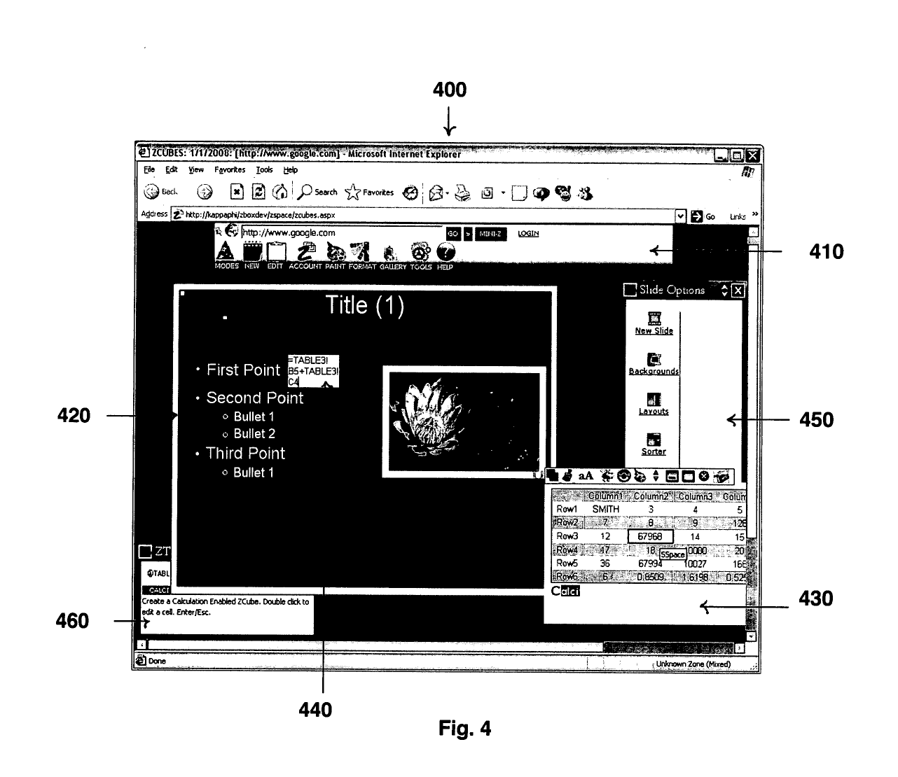

CALCI elements can be inserted into document elements, slide elements, drawing elements, etc. as small grids that have all calculation ability. FIG. 4 depicts a recursive browser window 400 having an action bar 410. The recursive browser window contains a slide 420 which references table 430 as a full expression 440 therein that is evaluation for every reevaluation of expressions in the ZSpace. This is an essential hallmark of omni-functionality of a document, where functionalities of all types intersperse throught the document. Although these are small elements, they have the full capabilities of CALCI and may be a grid with more than one cell. Also the recursive browser window displays ZCubes comprising Slide Options 450 and ZTips 460, both of which may be be accessed from the action bar providing instructions to create a calculation enabled ZCube.

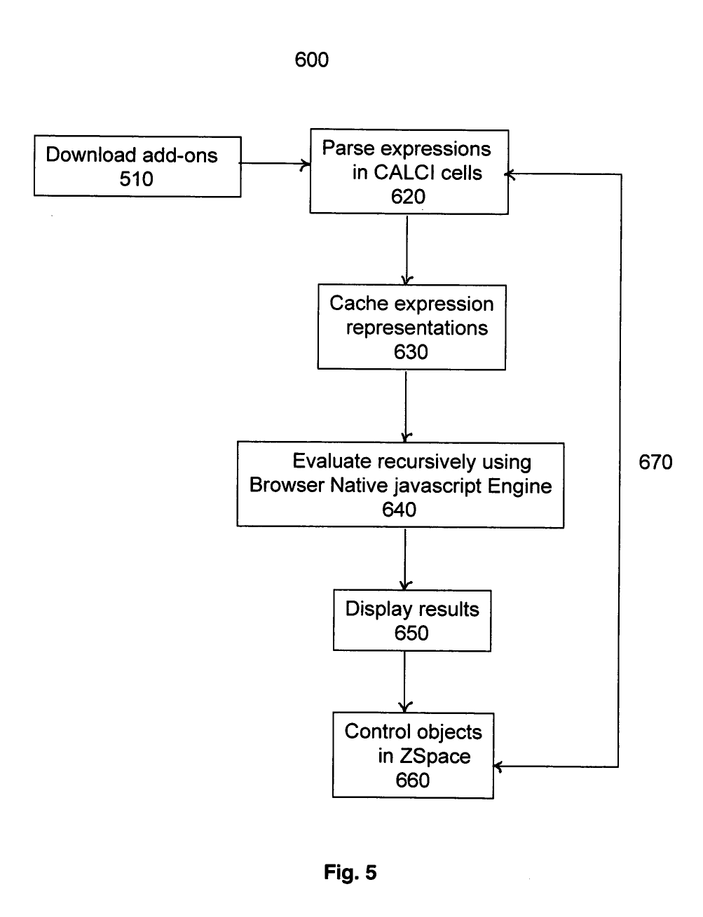

FIG. 5 is a flowchart 500 depicting the general steps to use CALCI. Optionally, at step 510 any add-ons are downloaded by a user to CALCI. Expression(s) in CALCI cells are parsed at step 520 and the expression(s) representation(s) are cached at step 530. The expression(s) are evaluated recursively using a browser native JAVASCRIPT engine at step 540 and the results are displayed at step 550. At step 560 the displayed objects may be controlled in ZSpace. Step 570 indicates that the control in ZSpace of the displayed objects includes returning to step 520 for another iteration in CALCI or that expression(s) parsed at step 520 may be subject to control in ZSpace instead of caching expression(s) representation(s) at step 530.

One skilled in the art will appreciate readily that the present invention is well adapted to carry out the objects and obtain the ends and advantages inherent herein. The present examples, along with the methods, procedures, systems, and/or applications described herein are presently representative of preferred embodiments, are exemplary and are not intended as limitations on the scope of the invention. Changes therein and other uses will occur to those skilled in the art which are encompassed within the spirit of the invention as defined by the scope of the claims.

What is claimed is:

1. A computer-implemented method performed by a recursive web browser system for activating a table within a recursive webpage, comprising:
displaying, as a recursive webpage segment, one or more tables comprising one or more cells within one or more ZCubes in a ZSpace of a recursive browser window; and
applying one or more functions supported by the ZCube(s) to one or more cells thereby activating the table(s).

2. The computer-implemented method of claim 1, further comprising storing the activated table(s) on a tangible computer storage medium or in a computer memory.

3. The computer-implemented method of claim 1, wherein triggering animation or other logic from the table cell(s) is a client driven process effective to change the document object model without changing the table itself.

4. The computer-implemented method of claim 1, wherein the step of applying function(s) comprises applying one or more standard spreadsheet calculational functions from within the webpage segment to the one or more table cells, said webpage segment containing the logic therefor.

5. The computer-implemented method of claim 1, wherein the step of applying function(s) comprises applying one or more control structures to the one or more table cells, said control structures operable to execute cell instructions based on values or conditions in another cell instruction during calculation iterations.

6. The computer-implemented method of claim 5, wherein the control structures are time-triggered.

7. The computer-implemented method of claim 1, wherein the step of applying function(s) comprises dragging and dropping content into the cell(s); and
expanding the cell(s) to display the content therein.

8. The computer-implemented method of claim 7, wherein the content comprises a picture(s) or a web link.

9. The computer-implemented method of claim 1, wherein the step of applying function(s) comprises integrating one or more behavioral effects into the cell(s).

10. The computer-implemented method of claim 7, wherein the applied effect comprises rotating the cell(s) or is a special effect that is integrable within the cell(s).

11. The computer-implemented method of claim 1, wherein the step of applying function(s) comprises inputting numbers or other representational values or pictures into one or more cells of one or more tables via drag/drop or copy/paste actions or AJAX calls from other data sources.

12. The computer-implemented method of claim 11, further comprising:
converting the table(s) automatically into lookup tables or into recursive 3-D calculation engine(s) having an HTML interface (CALCI); and
applying further standard calculational functions thereto.

13. The computer-implemented method of claim 1, wherein the webpage segment contains logic for the one or more functions.

14. The computer-implemented method of claim 1, wherein the webpage segment further comprises one or more models having a formula input and output, said model(s) comprising one or more function blocks.

15. The computer-implemented method of claim 1, wherein the webpage segment further comprises one or more floating recursive 3-D calculation engines that provide a calculation medium.

16. The computer-implemented method of claim 1, wherein one or more cells contain one or more pictures, one or more numbers, one or more complex numbers, a coordinate set, a recursive 3-D calculation engine, or a calendar.

17. The computer-implemented method of claim 1, wherein the table cell(s) comprise a recursive 3-D calculation engine with an HTML interface (CALCI) that is activatable and deactivatable within ZSpace.

18. The computer-implemented method of claim 17, further comprising:
dynamically loading add-ons comprising domain specific functions within ZSpace to enhance the same or to add to functions used in CALCI.

19. The computer-implemented method of claim 17, wherein the recursive browser window comprises an action bar, the method further comprising:
statically evaluating the CALCI cell(s) within the action bar without changing the previous value of the cell unless a specific user-action or event is implemented.

20. The computer-implemented method of claim 17, further comprising:
dragging the CALCI within the recursive webpage segment to implement a resizing of the CALCI whereupon the table resizes accordingly.

21. The computer-implemented method of claim 17, wherein CALCI cells are interconnected and interchangeable.

22. The computer-implemented method of claim 17, wherein CALCI implements one or more method steps comprising expanding a URL dragged and dropped therewithin or appending and merging elements from one or more other CALCI therewithin or inserting elements thereof into one or more of document elements, slide elements or drawing elements as a grid with calculation ability.

23. The computer-implemented method of claim 17, wherein CALCI implements method steps comprising selecting one or more vector objects in the ZSpace and manipulating the vector object(s) via mathematical expressions and JAVASCRIPT code entered into one or more CALCI cells.

24. The computer-implemented method of claim 17, wherein CALCI implements a method step comprising referring to other CALCI cell(s), an HTML object, an XHTML object or an XML object in ZSpace via one or more formulas contained therein or via NetVariables.

25. The computer-implemented method of claim 17, wherein CALCI implements method steps comprising showing a help feature for a ZCube API function upon its entry into CALCI by matching the function prefix to the closest API function name and accepting the entered function upon pressing the keyboard space bar.

26. The computer-implemented method of claim 17, wherein CALCI implements a method step comprising enabling shortcuts to calculational functions upon entry of one or more keystrokes assigned to represent the function.

27. The computer-implemented method of claim 17, wherein CALCI implements a method step comprising graphically or pictorially representing a number within a cell, including the graphical or pictorial representation of a value resulting from a calculation applied to one or more cells containing the representations.

28. The computer-implemented method of claim 17, wherein CALCI implements a method step comprising entering a multidimensional array into a cell thereof using a notation [[2,3],[4,3]].

29. The computer-implemented method of claim 17, wherein CALCI comprises a model formula having a name and one or more input parameters at specific identifiable locations therewithin; wherein CALCI implements a method step comprising calculating output values from the input parameters comprising the model, said output values used in further calculations therewithin.

30. A computer program product, comprising:
a tangible computer useable medium having a computer readable program, wherein the computer readable program, when executed in a recursive web browser system on a client computer comprising at least a memory and a processor, causes the client computer to:
provide one or more activatable tables defining one or more cells therein within one or more recursive webpage segments in a ZCube in a ZSpace of a recursive browser window; and
access one or more ZCube supported functions applicable to the cell(s) comprising the activatable table, wherein the recursive webpage segment(s) contains the function logic therein.

31. The computer program product of claim 30, wherein the client computer further triggers animation or other logic from the table cell(s) and in a manner effective to change the document object model without changing the table itself.

32. The computer program product of claim 30, wherein the webpage segment further comprises one or more models having a formula input and output, said model(s) comprising one or more function blocks.

33. The computer program product of claim 30, wherein the webpage segment further comprises one or more floating recursive 3-D calculation engines that provide a calculation medium.

34. The computer program product of claim 30, wherein one or more cells contain one or more pictures, one or more numbers, one or more complex numbers, a coordinate set, a recursive 3-D calculation engine, or a calendar.

35. The computer program product of claim 30, wherein the applied functions are standard spreadsheet calculational functions contained within the webpage segment.

36. The computer program product of claim 30, wherein the applied function(s) comprises one or more control structures operable to execute cell instructions based on values or conditions in another cell instruction during calculation iterations.

37. The computer program product of claim 36, wherein the control structures are time-triggered.

38. The computer program product of claim 30, wherein the applied functions are behavioral functions operable to integrate a behavioral effect into the cell(s).

39. The computer program product of claim 38, wherein the behavioral effect is cell rotation or a special effect that is integrable within the cell(s).

40. The computer program product of claim 30, wherein the applied function is a drag/drop function or copy/paste function or where the applied function enables AJAX calls from other data sources.

41. The computer program product of claim 40, wherein the functions operate to input content into the cell(s) comprising the activatable table(s).

42. The computer program product of claim 41, wherein the content is one or more numbers or other representational values.

43. The computer program product of claim 41, wherein the functions further operate to convert the table(s) automatically into lookup tables or into a recursive 3-D calculation engine contained with an HTML interface (CALCI) and to apply further calculational functions thereto.

44. The computer program product of claim 40, wherein the dragged/dropped content comprises a picture or a web link, said functions operable to further expand the cell to display the content therein.

45. The computer program product of claim 30, wherein the table cell(s) comprise a recursive 3-D calculation engine with an HTML interface (CALCI) that is activatable and deactivatable within ZSpace.

46. The computer program product of claim 45, wherein the functions operate to dynamically load add-ons comprising domain specific functions within ZSpace to enhance the same or to add to functions used in CALCI.

47. The computer program product of claim 45, wherein the recursive browser window comprises an action bar, the functions further operating to statically evaluate the CALCI cell(s) within the action bar without changing the previous value of the cell unless a specific user-action or event is implemented.

48. The computer program product of claim 45, wherein the functions operate to drag the CALCI within the recursive webpage segment and to resize the CALCI, said functions further operable to resize the activatable table accordingly.

49. The computer program product of claim 45, wherein CALCI operates to expand a URL dragged and dropped therewithin or to append and merge elements from one or more other CALCI therewithin or to insert elements thereof into one or more of document elements, slide elements or drawing elements as a grid with calculation ability.

50. The computer program product of claim 45, wherein CALCI operates to select one or more vector objects in the ZSpace and to manipulate the vector object(s) via mathematical expressions and JAVASCRIPT code entered into one or more CALCI cells.

51. The computer program product of claim 45, wherein the CALCI cell operates via one or more formulas contained therein or via NetVariables to refer to other CALCI cell(s), an HTML object, an XHTML object or an XML object in ZSpace.

52. The computer program product of claim 45, wherein CALCI operates to show a help feature for a ZCube API function upon its entry into CALCI by matching the function prefix to the closest API function name and to accept the entered function upon pressing the keyboard space bar.

53. The computer program product of claim 45, wherein CALCI operates to enable shortcuts to calculational functions upon entry of one or more keystrokes assigned to represent the function.

54. The computer program product of claim 45, wherein CALCI operates to graphically or pictorially represent a number within a cell, including the graphical or pictorial representation of a value resulting from a calculation applied to one or more cells containing the representations.

55. The computer program product of claim 45, wherein CALCI operates to enter a multidimensional array into a cell thereof using a notation [[2,3],[4,3]].

56. The computer program product of claim 45, wherein CALCI comprises a model formula having a name and one or more input parameters at specific identifiable locations therewithin; wherein CALCI operates to calculate output values from the input parameters comprising the model, said output values used in further calculations therewithin.

57. The computer program product of claim 45, wherein CALCI cells are interconnected and interchangeable.

58. A recursive computer system for activating one or more activatable tables within a segment of a recursive webpage, comprising:
a computer having a processor and a recursive web browser configured to recursively display in a browser window thereof one or more recursive webpages having one or more activatable tables contained therein; and
a computer memory coupled to the processor storing the computer program product of claim 18 and further storing instructions adapted to be executed by the processor to at least enable operation thereof within the recursive webpages.

59. The recursive computer system of claim 58, further comprising means for storing the computer program product onto a computer-readable storage medium.

60. The recursive computer system of claim 58, further comprising means for launching a user-requested action to create or retrieve one or more activatable tables.

61. The recursive computer system of claim 60, wherein said means for launching a user-requested action is an action bar within a recursive browser window or an address bar located in a browser platform associated with the recursive web browser which triggers the action bar.

62. The recursive computer system of claim 61, wherein the user-requested action comprises a static evaluation of a CALCI comprising the activatable table.

63. The recursive computer system of claim 58, further comprising a network connection to one or more other computers having a recursive web browser comprising a network.
